(19) United States
(12) Patent Application Publication
(10) Pub. No.: US 2024/0298223 A1
(43) Pub. Date: Sep. 5, 2024

(54) OPTIMIZING METHOD FOR CONDITIONAL PRIMARY SECONDARY CELL ADDITION, TERMINAL, AND NETWORK DEVICE

(71) Applicant: GUANGDONG OPPO MOBILE TELECOMMUNICATIONS CORP., LTD., Dongguan (CN)

(72) Inventor: Yang LIU, Dongguan (CN)

(73) Assignee: GUANGDONG OPPO MOBILE TELECOMMUNICATIONS CORP., LTD., Dongguan (CN)

(21) Appl. No.: 18/665,560

(22) Filed: May 16, 2024

Related U.S. Application Data
(63) Continuation of application No. PCT/CN2021/132463, filed on Nov. 23, 2021.

(51) Int. Cl. H04W 36/00; H04W 36/08

(52) U.S. Cl. CPC H04W 36/0069; H04W 36/0058; H04W 36/08

(57) ABSTRACT

An optimizing method for conditional primary secondary cell addition, a terminal, and a network device are disclosed. The optimizing method is performed by the terminal, including: sending first information, the first information being configured to optimize configuration information of the conditional PSCell addition.

### CROSS REFERENCE TO RELATED APPLICATIONS

The present disclosure is a continuation of International Patent Application No. PCT/CN2021/132463, filed Nov. 23, 2021, the contents of which is herein incorporated by reference in its entirety.

### TECHNICAL FIELD

The present disclosure relates to the field of mobile communications, and in particular to an optimizing method for conditional primary secondary cell addition, a terminal, and a network device.

### BACKGROUND

Conditional PSCell addition/change (CPAC) is a technology that a terminal automatically adds/changes a primary secondary cell (PSCell) when a trigger condition is satisfied.

In related art, the trigger condition and an access resource of the CPAC are configured for the terminal by a network side. The access resource includes a random access preamble and a cell radio-network temporary identifier (C-RNTI) reserved by a candidate target PSCell for the terminal to avoid competition.

An issue of reserving the access resource in an unreasonable way exists. For example, when an excessive amount of access resource is reserved, some access resource may be wasted and a random access process of another potential terminal may be affected. For another example, when a limited amount of access resource is reserved, the terminal may only add a PSCell through a traditional PSCell addition process, which is time-consuming.

### SUMMARY OF THE DISCLOSURE

In a first aspect, some embodiments of the present disclosure provide an optimizing method for the conditional PSCell addition, the method is performed by a terminal, and the method may include: sending first information. The first information is configured to optimize configuration information of the conditional PSCell addition.

In a second aspect, some embodiments of the present disclosure provide a terminal. The terminal includes a processor, a memory, and a transceiver. The transceiver is configured to the connect to the processor. The memory is configured to store instructions to be executed by the processor. The processor is configured to load and execute the instructions to perform an optimizing method for the conditional PSCell addition and the optimizing method includes sending first information. The first information is configured to optimize configuration information of the conditional PSCell addition.

In a third aspect, some embodiments of the present disclosure provide a network device. The network device includes a processor, a memory, and a transceiver. The transceiver is configured to the connect to the processor. The memory is configured to store instructions to be executed by the processor. The processor is configured to load and execute the instructions to perform an optimizing method for the conditional PSCell addition and the optimizing method includes: receiving first information and optimizing configuration information of the conditional PSCell addition according to the first information.

### BRIEF DESCRIPTION OF THE DRAWINGS

In order to clearly illustrate the technical solutions in the present disclosure, the following briefly illustrates drawings associated with embodiments of the present disclosure. Obviously, the drawings described as follows are only for some embodiments of the present disclosure. For an ordinary skilled in the art, other drawings may be derived based on the following drawings without creative work.

FIG. 1 is a schematic view of a mobile communication system based on dual connectivity according to some embodiments of the present disclosure.

FIG. 2 is a schematic view of a contrast between a traditional PSCell addition process and a conditional PSCell addition process according to some embodiments of the present disclosure.

FIG. 3 is a principle schematic view of an optimizing method for the conditional PSCell addition, according to some embodiments of the present disclosure.

FIG. 4 is a flowchart of an optimizing method for the conditional PSCell addition according to some embodiments of the present disclosure.

FIG. 5 is a flowchart of an optimizing method for the conditional PSCell addition according to some embodiments of the present disclosure.

FIG. 6 is a flowchart of an optimizing method for the conditional PSCell addition according to some embodiments of the present disclosure.

FIG. 7 is an optimization schematic view of an optimizing method for the conditional PSCell addition according to some embodiments of the present disclosure.

FIG. 8 is a flowchart of an optimizing method for the conditional PSCell addition according to some embodiments of the present disclosure.

FIG. 9 is a structural block view of an optimizing apparatus for the conditional PSCell addition according to some embodiments of the present disclosure.

FIG. 10 is a structural block view of an optimizing apparatus for the conditional PSCell addition according to some embodiments of the present disclosure.

FIG. 11 is a structural view of a terminal according to some embodiments of the present disclosure.

FIG. 12 is a structural view of a network device according to some embodiments of the present disclosure.

### DETAILED DESCRIPTION

To clarify the purposes, technical solutions, and advantages of the present disclosure, various embodiments of the present disclosure will be further described in detail based on the drawings.

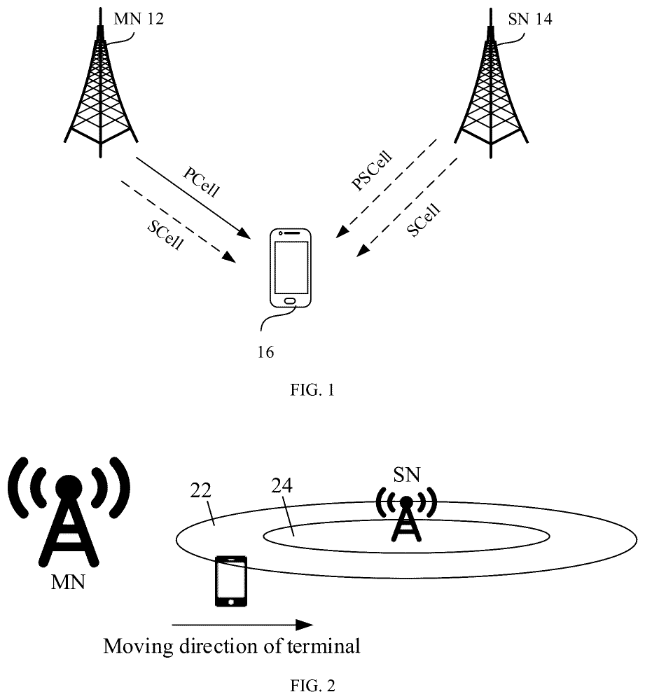

FIG. 1 is a schematic view of a mobile communication system based on dual connectivity according to some embodiments of the present disclosure. The mobile communication system includes: a master node (MN) 12, a primary node (SN) 14, and a terminal 16.

The MN 12 includes the following cells: a primary cell (PCell) and a secondary cell (SCell). The cells of the MN 12 are collectively referred to as a MasterCellGroup (MCG).

The SN 14 includes the following cells: a primary secondary cell (PSCell) and a SCell. The cells of the SN 14 are collectively referred to as a SecondaryCellGroup (SCG).

The purpose of the dual connectivity is to improve throughput of the terminal 16 that has accessed to the PCell and is in a connected state. That is, the cells of the SN 14 are configured to provide additional spectrum resource for the terminal.

Each of the MN 12 and SN 14 described above is an access network device, and the access network device is a device deployed in an access network for providing mobile communication functionality to the terminal 16. The access network device may include various forms of a macro base station, a micro base station, a relay station, an access point, a location management function (LMF) entity, and so on. In systems using different wireless access technologies, names of the devices that are provided with access network device functionality may be different. For example, in a 5G NR system, the device is called a gNodeB or a gNB. The name “access network device” may change as the communication technology evolves. For convenience of description, in the embodiments of the present disclosure, the above-described devices that provide the mobile communication functionality to the terminal 16 are collectively referred to as the access network device. A connection may be established between the access network device and the terminal 16 through an air interface, and communications, including a signaling and data interaction, may be carried out through the connection. There may be more than one access network device, and the communications between two neighbour access network devices may be carried out in a wired or wireless means. The terminal 16 may switch between different access network devices, i.e., establish connections with different access network devices.

There is typically more than one terminal 16, and the one or more terminals 16 may be distributed within cells managed by each the access network device. The terminal 16 may include a variety of handheld devices, in-vehicle devices, wearable devices, computing devices or other processing devices connected to a wireless modem, which are provided with the mobile communication functionalities, and various forms of user equipment (UE), mobile station (MS), and so on. For convenience of description, in the embodiments of the present disclosure, the above-mentioned devices are collectively referred to as the terminal 16.

A “5G NR system” in the embodiments of the present disclosure may be further referred to as a 5G system or an NR system, but a skilled in the art may understand the meaning thereof. The technical solutions described in the embodiments of the present disclosure may be applicable to the 5G NR system or a subsequent evolutionary system of the 5G NR system.

### A Traditional PSCell Addition Process:

1. The MN sends a measurement configuration to the terminal, and the measurement configuration includes an air interface frequency to be measured, a measurement reporting event, and so on.
2. The terminal carries out a measurement according to the measurement configuration sent from the MN. When a measurement result satisfies a measurement reporting event, the terminal reports a corresponding measurement report to the MN.
3. Based on the measurement report of the PCell reported by the terminal, the MN finds a suitable target SN and a suitable target PScell, and indicates the terminal to access the suitable target PScell.

Differences between the conditional PSCell addition process and the traditional PSCell addition process:

The traditional PSCell addition requires that the terminal reports the measurement result first, the MN communicates with the target SN according to the measurement result, and the MN then sends an access resource of the target PSCell reserved by the target SN to the terminal to enable the terminal to access the target SN. While, for the conditional PSCell addition, the MN may communicate in advance with a candidate target SN (which may be more than one) regarding a reserved access resource to be sent to the terminal, and then send an addition trigger condition (i.e., a signal threshold) of PSCell addition in conjunction with information of a candidate target PSCell to the terminal. When the addition trigger condition is satisfied, the terminal may perform the PSCell addition independently. In this way, SN addition may become faster and better adaptive to a current state of the terminal.

It should to be noted, for the traditional PSCell addition process and the conditional PSCell addition process, signal thresholds corresponding to the same reporting/execution events are different. Obviously, less time is required by the terminal to perform the conditional PSCell addition, so the terminal may perform the conditional PSCell addition at a position closer to the target PSCell. For the traditional PSCell addition process, more time is required before the terminal starts to perform the PSCell addition, which then requires the terminal to perform event reporting earlier. As illustrated in FIG. 2, a signal threshold of the traditional PSCell addition process corresponds to a signal range 22, a signal threshold of the conditional PSCell addition process corresponds to a signal range 24, and the signal range 22 is larger than the signal range 24. A reporting/execution event of the traditional PSCell addition process may be triggered in response to the terminal moving into the signal range 22; and the conditional PSCell addition process may be additionally triggered only in response to the terminal moving into the signal range 24.

### SCG Failure Information Reporting

In response to the terminal encountering problems, e.g. random access, when accessing a new PSCell, or encountering a problem of detecting RadioLinkFailure (RLF) on the SCG after accessing the target PScell, the terminal may report a SCG failure information reporting to the MN that has previously provided the measurement configuration to help the MN adjust the addition trigger condition, i.e., the signal threshold, of the conditional PSCell addition for the terminal.

Specifically, the following parameters are reported.

A Failuretype, which indicates a reason of failure, and two main reasons include the RLF due to bad quality of air interface link and random access problem when the terminal accesses the target PSCell.

A MeasResultFreqList, which includes a measurement result at a measurement frequency for which the terminal is configured.

Location information, which is a physical location of the terminal when the SCG failure occurs.

A4 Event (a Measurement Result of a Neighbour Cell is Greater than a Threshold)

An A4 event is triggered in response to a measurement result of a neighbour cell being better than a preset signal threshold. The A4 event may be configured for a switch process that is independent of a range of service cell. For example, in load balancing, the terminal is determined to switch from the service cell according to a load condition rather than a wireless condition. In this case, the terminal only needs to detect whether a target cell is better than a certain signal level value and is able to provide sufficient range.

Mn+Ofn+Oen−Hys>Thresh (Trigger Condition)

Mn+Ofn+Oen+Hys<Thresh (Cancellation Condition)

B1 Event (Inter RAT Neighbour Cell is Better than a Threshold)

A B1 event is configured for an inter-system switch process and is independent of the range of service cell. For example, in load balancing, a UE is determined to switch from a 5G (NR) network according to the load condition rather than the wireless condition. In this case, the UE only needs to detect whether a target cell of another network, e.g., LTE, is better than a certain signal level threshold and is able to provide sufficient range.

Mn+Ofn+Ocn−Hys>Thresh (Trigger Condition)

Mn+Ofn+Ocn+Hys<Thresh (Cancellation Condition)

Mn is a measurement result of the neighbour cell, for example, a reference signal received power (RSRP) of the neighbour cell. Ofn is an offset of the inter-RAT neighbour cell. Ocn is an offset of the neighbour cell. Hys is a hysteresis parameter for a current event. Thresh is a threshold parameter. The Mn is expressed in dBm in case of RSRP, or in dB in case of RSRQ and RS-SINR. The Ofn, the Ocn, and the Hys are expressed in dB. The Thresh is expressed in the same unit as the Mn.

Since contents in SCG failure information reporting are limited, the MN is unable to determine, according to the reporting, how long the access resource need to be reserved for the terminal, and does not know whether the terminal adds the candidate PSCell too early, which may lead to the SCG failure, or the terminal requests the PSCell change shortly after adding the PSCell.

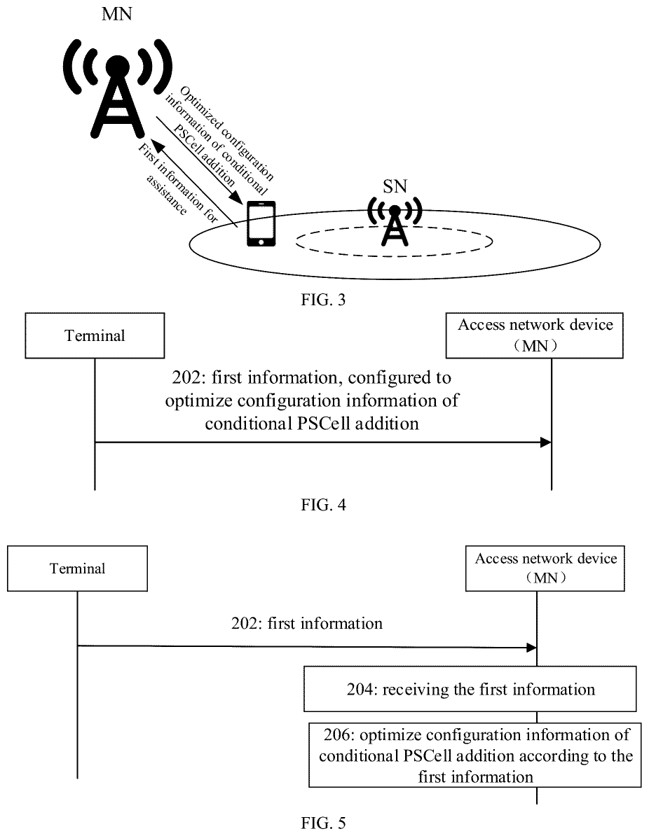

Therefore, the embodiments of the present disclosure provide a technical solution for the terminal to assist the network in optimizing the configuration of the conditional PSCell addition process. As illustrated in FIG. 3, after performing the conditional PSCell addition process, the terminal reports first information to the network, and the first information is relevant to the conditional PSCell addition; the network optimizes configuration information of the conditional PSCell addition process of the terminal according to the first information. With the assistance of the first information reported by the terminal, the network reissues the optimized configuration information of the conditional PSCell addition process to the terminal.

FIG. 4 is a flowchart of an optimizing method for the conditional PSCell addition according to some embodiments of the present disclosure. The present embodiment is exemplified by the method being executed by the terminal. The method includes the following operations.

At block 202, a terminal sends first information to a network device. The first information is configured to optimize configuration information of conditional PSCell addition.

The first information includes at least one of the following information.
Relevant information of the conditional PSCell addition process performed by the terminal in history.
Relevant information of the conditional PSCell addition process performed by the terminal using historical configuration information.
Information related to the conditional PSCell addition process performed in history.
Relevant information of a traditional PSCell addition process performed by the terminal in history.
Relevant information of the traditional PSCell addition process performed by the terminal using historical configuration information.
Information related to the traditional PSCell addition process performed in history.

The first information is configured for the network device to optimize the configuration information of the conditional PSCell addition process.

The first information is sent from the terminal when the (historical) conditional PSCell addition process fails. Alternatively, the first information is sent from the terminal when the (historical) conditional PSCell addition process successes. Alternatively, the first information is sent from the terminal when the (historical) conditional PSCell addition process successes but some parameters satisfy a reporting trigger condition.

The first information is carried in a radio resource control (RRC) signaling. The first information is carried in the SCG failure information reporting. Alternatively, the first information is carried in an uplink information response. Alternatively, the first information is carried in a successful PSCell addition information reporting. Alternatively, the first information is carried in an uplink signaling of a new type.

In some embodiments, the terminal firstly sends indication information to the network device, and the indication information is configured to indicate that the terminal has the first information. The terminal receives a reporting signaling sent from the network device, and the reporting signaling is configured to indicate the terminal to send the first information. In response to receiving the reporting signaling, the terminal sends the first information to the network device. The indication information is bits carried in the SCG failure information reporting.

In some embodiments, the first information is configured to optimize the access resource reserved in the conditional PSCell addition process, and/or, to optimize an addition trigger condition in the conditional PSCell addition process.

In some embodiments, the first information includes at least one following information.
A time difference between a first moment and a second moment. The first moment is a moment at which the terminal receives a signaling of the conditional PSCell addition, and the second moment is a moment at which the terminal performs the conditional PSCell addition.

The time difference between the first moment and the second moment is configured to assist the network side to optimize a period of a reserved access resource in the additional PSCell addition.
An addition trigger condition applied to at least one candidate PSCell (abbreviated as a candidate cell).

The addition trigger condition is configured to be referred by the network device when the network device performs optimization. For example, in response to the terminal performing the conditional PSCell addition too early, the signal threshold of the addition trigger condition may be decreased.

The addition trigger condition includes at least one of the following events.

Specific values or arrays of the A4 event (Neighbour becomes better than threshold), and specific values or arrays of the B1 event (Inter RAT neighbour becomes better than threshold).
A list and/or measurement result of the at least one candidate PSCell.

The list and/or measurement result of the at least one candidate PSCell is configured for the network device to optimize the candidate PSCell configured for the terminal, for example, to eliminate a candidate PSCell that is likely to fail.
A list and/or measurement result of at least one non-candidate PSCell.

The list and/or measurement result of the at least one non-candidate PSCell is configured for the network device to optimize the candidate PSCell configured for the terminal, for example, to increase a candidate PSCell of better signal quality.
A time difference between a third moment and a fourth moment. The third moment is a moment at which the PSCell addition is performed, and the fourth moment is a moment at which the SCG failure occurs.

The time difference between the third moment and the fourth moment is configured to determine whether the PSCell is added too early or is added mistakenly.

The third moment is a moment at which the conditional PSCell addition is performed, and/or, is a moment at which the traditional PSCell addition is performed.
Location information of the terminal when the PSCell addition is performed.

The location information of the terminal when the PSCell addition is performed is configured to determine a distance between the SN and the terminal when the PSCell addition is performed by the terminal, and whether the addition is performed too early.
Last location information recorded before the conditional PSCell addition is performed.
Location information of the terminal when the SCG failure occurs.

The location information of the terminal when the SCG failure occurs is configured to determine a distance between the SN and the terminal when the SCG failure occurs in the terminal, and whether the addition is performed too early.
Last location information recorded before the SCG failure occurs.
An addition trigger condition configured for the target PSCell.
A first indication or a second indication. The first indication is configured to indicate that the PSCell addition performed by the terminal is the conditional PSCell addition, and the second indication is configured to indicate that the PSCell addition performed by the terminal is the traditional PSCell addition.
A measurement result of the neighbour cell before the SCG failure occurs.

The measurement result of the neighbour cell is configured to determine whether the target PSCell added by the terminal is correct, so that the network may reserve the access resource of an appropriate PSCell.

In summary, in the method provided in the present embodiment, the first information is sent by the terminal to the network device, the first information being configured to optimize the configuration information of the conditional PSCell addition, such that the network device can optimize the access resource and the addition trigger condition configured for the conditional PSCell addition according to the first information. One aspect, this can avoid wasting the access resource, and another aspect, this may improve success rate of the conditional PSCell addition performed by the terminal.

FIG. 5 is a flowchart of an optimizing method for the conditional PSCell addition according to some embodiments of the present disclosure. The present embodiment is exemplified by the method being executed by the network device. The method includes the following operations.

At block 204, the network device receives the first information sent from the terminal.

The first information is sent from the terminal when the (historical) conditional PSCell addition process fails. Alternatively, the first information is sent from the terminal when the (historical) conditional PSCell addition process successes. Alternatively, the first information is sent from the terminal when the (historical) conditional PSCell addition process successes but some parameters satisfy a reporting trigger condition.

The first information is carried in the RRC signaling. The first information is carried in the SCG failure information reporting. Alternatively, the first information is carried in the uplink information response. Alternatively, the first information is carried in the successful PSCell addition information reporting. Alternatively, the first information is carried in the uplink signaling of the new type.

In some embodiments, the network device receives the indication information sent from the terminal, and the indication information is configured to indicate that the terminal has the first information. The network device sends a reporting signaling to the terminal, and the reporting signaling is configured to indicate the terminal to send the first information. In response to receiving the reporting signaling, the terminal sends the first information to the network device. The indication information is bits carried in the SCG failure information reporting. Alternatively, the indication information is carried in the successful PSCell addition information reporting.

At block 206, the network device optimizes configuration information of the conditional PSCell addition according to the first information.

In some embodiments, the first information is configured to optimize an access resource reserved in the conditional PSCell addition process, and/or, to optimize an addition trigger condition of the conditional PSCell addition process.

In summary, in the method provided in the present embodiment, the network device receives first information sent from the terminal, such that the network device may optimize the access resource and the addition trigger condition configured for the conditional PSCell addition according to the first information. One aspect, this can avoid wasting the access resource, and another aspect, this may improve the success rate of the conditional PSCell addition performed by the terminal.

### In Case of the Conditional PSCell Addition Failing (SCG Failure):

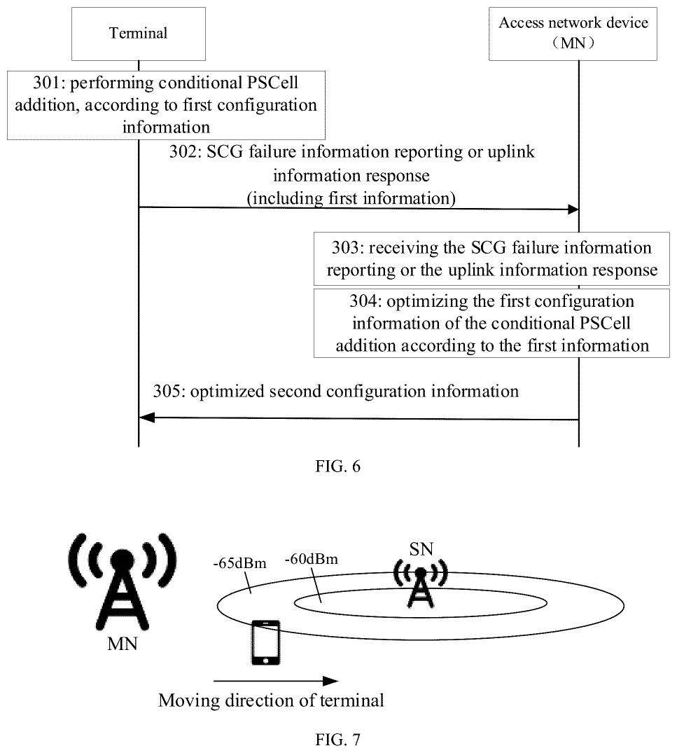

FIG. 6 is a flowchart of an optimizing method for the conditional PSCell addition according to some embodiments of the present disclosure. The present embodiment is exemplified by the method being executed by the network device and the terminal. The method includes the following operations.

At block 301, the terminal performs conditional PSCell addition according to first configuration information.

The first configuration information includes, but is not limited to, at least one of the addition trigger condition of the conditional PSCell addition and the access resource reserved by the candidate PSCell. The addition trigger condition includes: specific parameters of the A4 event and/or the B1 event.

At block 302, in response to the conditional PSCell addition failing, the terminal sends the SCG failure information reporting or the uplink information response to the network device. The SCG failure information reporting or the uplink information response carries the first information.

The terminal sends the SCG failure information reporting to the network device. One or more bits of the SCG failure information reporting are the indication information, and the indication information is configured to indicate that the terminal has the first information. The network device sends the reporting signaling to the terminal, the terminal sends the uplink information response to the network device, and the uplink information response carries the first information.

In some embodiments, the first information includes at least one of the following information.
The time difference between the first moment and the second moment. The first moment is a moment at which the terminal receives a signaling of the conditional PSCell addition, and the second moment is a moment at which the terminal performs the conditional PSCell addition.
The addition trigger condition applied to at least one candidate PSCell (abbreviated as the candidate cell).
The list and/or measurement result of the at least one candidate PSCell.

For example, a list and/or measurement result of at least one candidate PSCell when/before the conditional PSCell addition fails. For another example, a list and/or measurement result of at least one candidate PSCell when/before the SCG failure occurs.
The list and/or measurement result of the at least one non-candidate PSCell.

For example, a list and/or measurement result of at least one non-candidate PSCell when/before the conditional PSCell addition fails. For another example, a list and/or measurement result of at least one non-candidate PSCell when/before the SCG failure occurs.
The time difference between the third moment and the fourth moment. The third moment is a moment at which the PSCell addition is performed, and the fourth moment is a moment at which the SCG failure occurs.

The third moment is a moment at which the conditional PSCell addition is performed, and/or, is a moment at which the traditional PSCell addition is performed.
The location information of the terminal when the PSCell addition is performed.

For example, real-time location information of the terminal when the PSCell addition is performed by the terminal. For another example, last location information recorded before the conditional PSCell addition is performed.
The location information of the terminal.

For example, real-time location information of the terminal when the conditional PSCell addition fails. For another example, last location information recorded before the conditional PSCell addition fails. For another example, real-time location information of the terminal when the SCG failure occurs. For another example, the last location information recorded before the SCG failure occurs.
The addition trigger condition configured for the target PSCell.
The first indication or the second indication. The first indication is configured to indicate that the PSCell addition performed by the terminal is the conditional PSCell addition, and the second indication is configured to indicate that the PSCell addition performed by the terminal is the traditional PSCell addition.

For example, the first indication is for be conditional addition, and the second indication is for be commanded addition.
A measurement result of the neighbour cell when the conditional PSCell addition fails or before the SCG failure occurs.

At block 303, the network device receives the SCG failure information reporting or the uplink information response.

The network device obtains the first information from the SCG failure information reporting or the uplink information response.

At block 304, the network device optimizes the first configuration information of the conditional PSCell addition according to the first information.

The network device, according to the first information, optimizes one of the following of the conditional PSCell addition: a range of the candidate PSCell, the number of the candidate PSCell, an addition trigger condition, a period of a reserved access resource, and the number of reserved access resources.

Further referred to FIG. 7, the MN assigns the A4 event, reported by an addition measurement event of the traditional SN, to the terminal. The signal threshold of the A4 event is −65 dBm.

The terminal satisfies a measurement reporting condition in a moving process, and reports the condition to the MN. After the MN negotiates with the SN, the terminal may be determined by the MN to initiate the conditional PSCell addition, then dedicated access resource and an addition trigger condition (−63 dBm) of the candidate PSCell are sent to the terminal by the MN. As the terminal moves, the terminal detects that a cell signal quality of the candidate PSCell satisfies the addition trigger condition, and adds the PSCell using the dedicated access resource reserved for the terminal by the MN.

The SCG failure occurs in the terminal as the RLF is triggered due to unstable air interface link or a timer T304 of the SCG timeouts when the target PSCell is accessed. The terminal reports the SCG failure information reporting to the MN. The MN compares the first information, i.e., “the time difference between the first moment at which the PSCell addition is performed and the second moment at which the SCG failure occurs” with a fixed threshold. In response to the time difference being less than the preset threshold, the MN determines that the current failure belongs to an event where the PSCell is added too early.

The MN, according to the configuration information reported by the terminal, increases a threshold of the PSCell addition at the similar location to −63 dBm.

At block 305, the network device sends optimized second configuration information to the terminal.

The network device sends the optimized second configuration information, for example, the signal threshold of the A4 event being −60 dBm, to the current terminal or other terminals near the current terminal. That is, the second configuration information is the optimized first configuration information.

In summary, in the method provided in the present embodiment, the network device receives the first information sent from the terminal, such that the network device optimizes the access resource and the addition trigger condition configured for the conditional PSCell addition according to the first information. One aspect, this can avoid wasting the access resource, and another aspect, this may improve the success rate of the conditional PSCell addition performed by the terminal and reduce possibility of the SCG failure.

### In Case of the Successful Conditional PSCell Addition:

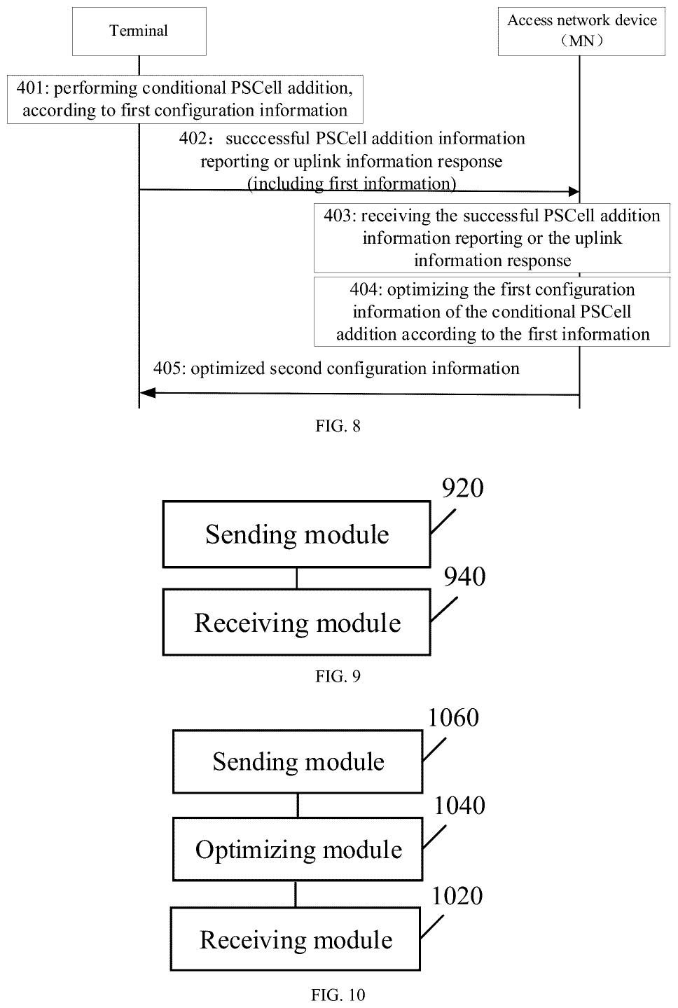

FIG. 8 is a flowchart of an optimizing method for the conditional PSCell addition according to some embodiments of the present disclosure. The present embodiment is exemplified by the method being executed by the terminal and the network device. The method includes the following operations.

At block 401, the terminal performs conditional PSCell addition according to first configuration information.

The first configuration information includes, but is not limited to, at least one of the addition trigger condition of the conditional PSCell addition and the access resource reserved by the candidate PSCell. The addition trigger condition includes: specific parameters of the A4 event and/or the B1 event.

At block 402, in response to the conditional PSCell addition successing, the terminal sends a successful PSCell addition information reporting or an uplink information response to the network device. The successful PSCell addition information reporting or the uplink information response carries the first information.

The terminal sends the successful PSCell addition information reporting to the network device. The successful PSCell addition information reporting carries the first information. Alternatively, the terminal sends the uplink information response to the network device, and the uplink information response carries the first information.

The terminal sends the successful PSCell addition information reporting to the network device. One or more bits of the successful PSCell addition information reporting are the indication information, and the indication information is configured to indicate that the terminal has the first information. The network device sends a reporting signaling to the terminal, the terminal sends the uplink information response to the network device, and the uplink information response carries the first information.

In response to the conditional PSCell addition successing and the reporting trigger condition being satisfied, the terminal sends the first information to the network device. The reporting trigger condition includes at least one of the following conditions.
A time difference between the first moment and the second moment is greater than a first threshold. The first moment is a moment at which the terminal receives a signaling of the conditional PSCell addition, and the second moment is a moment at which the terminal performs the conditional PSCell addition.

The time difference that is greater than the first threshold indicates that the moment at which the terminal performs the conditional PSCell addition is too late.
A time difference between the second moment and a fifth moment is greater than a second threshold. The second moment is a moment at which the terminal performs the conditional PSCell addition, and the fifth moment is a moment at which the conditional PSCell addition is successfully finished.

The time difference that is greater than the second threshold indicates that the terminal may encounter the random access problem and fails to access a target PSCell successfully. For example, when a relatively limited amount of access resource is reserved in the first configuration information, the terminal needs to wait for a relatively long time before accessing the target PSCell.

The first threshold is preset, or preconfigured, or configured by the network device. The second threshold is preset, or preconfigured, or configured by the network device.

In some embodiments, the first information includes at least one of the following information.
The time difference between the first moment and the second moment. The first moment is a moment at which the terminal receives a signaling of the conditional PSCell addition, and the second moment is a moment at which the terminal performs the conditional PSCell addition.
The addition trigger condition applied to at least one candidate PSCell (abbreviated as the candidate cell).
The list and/or measurement result of the at least one candidate PSCell.

For example, a list and/or measurement result of at least one candidate PSCell when/before the conditional PSCell addition successes.
The list and/or measurement result of the at least one non-candidate PSCell.

For example, a list and/or measurement result of at least one non-candidate PSCell when/before the conditional PSCell addition successes.
The location information of the terminal when the PSCell addition is performed.

For example, the real-time location information of the terminal when the PSCell addition is performed by the terminal. For another example, the last location information recorded before the conditional PSCell addition is performed.
A location information of the terminal when the PSCell addition successes.

For example, real-time location information of the terminal when the PSCell addition successes. For another example, last location information recorded before the PSCell addition successes.
The addition trigger condition configured for the target PSCell.
The first indication or the second indication. The first indication is configured to indicate that the PSCell addition performed by the terminal is the conditional PSCell addition, and the second indication is configured to indicate that the PSCell addition performed by the terminal is the traditional PSCell addition.
A measurement result of the neighbour cell before the PSCell addition successes.

At block 403, the network device receives the successful PSCell addition information reporting or the uplink information response.

The network device obtains the first information from the successful PSCell addition information reporting or the uplink information response.

In an example, the first information includes: a measurement result of a neighbour cell when the PSCell addition successes, the time difference between the first moment and the second moment, and the location information of the terminal when the PSCell addition successes.

At block 404, the network device optimizes the first configuration information of the conditional PSCell addition according to the first information.

The network device, according to the first information, optimizes one of the following in the conditional PSCell addition: a range of the candidate PSCell, the number of the candidate PSCell, the addition trigger condition, a period of a reserved access resource, and the number of reserved access resources.

The MN, according to the first information, adjusts a range/amount of candidate PSCells configured for the terminal. For example, when a measurement result of a cell 3 indicates that the cell 3 is suitable as the candidate PSCell but is not within the range of the candidate PSCell, the MN will add the cell 3 in the candidate cell afterwards. For another example, the MN optimizes the reserved period of the dedicated access resource of the candidate PSCell for the terminal accordingly. For example, when an actual evaluation time of the terminal is 2 seconds but a period of the dedicated access resource reserved for the terminal is 7 seconds, the MN may reduce the period in the optimized second configuration information afterwards.

At block 405, the network device sends the optimized second configuration information to the terminal.

The network device sends the optimized second configuration information to the current terminal or other terminals in a similar terminal.

In summary, in the method provided in the present embodiment, the network device receives the first information sent from the terminal, such that the network device optimizes the access resource and the addition trigger condition configured for the conditional PSCell addition according to the first information. One aspect, this can avoid wasting the access resource, and another aspect, this may improve the success rate of the conditional PSCell addition performed by the terminal, and reduce the possibility of the SCG failure.

FIG. 9 is a structural block view of an optimizing apparatus for the conditional PSCell addition according to some embodiments of the present disclosure. The optimizing apparatus may be applied in the terminal by a software, or a hardware, or a combination of both. The optimizing apparatus includes the following.

A sending module 920 is configured to send first information. The first information is configured to optimize configuration information of conditional PSCell addition.

In some embodiments, the first information includes at least one of the following information.
A time difference between a first moment and a second moment. The first moment is a moment at which the terminal receives a signaling of the conditional PSCell addition, and the second moment is a moment at which the terminal performs the conditional PSCell addition.
An addition trigger condition applied to at least one candidate PSCell.
A list and/or measurement result of the at least one candidate PSCell.
A list and/or measurement result of at least one non-candidate PSCell.
A time difference between a third moment and a fourth moment. The third moment is a moment at which the PSCell addition is performed, and the fourth moment is a moment at which the SCG failure occurs.

### Location Information of the Terminal.

An addition trigger condition configured for a target PSCell.

A first indication or a second indication. The first indication is configured to indicate that the PSCell addition performed by the terminal is the conditional PSCell addition, and the second indication is configured to indicate that the PSCell addition performed by the terminal is traditional PSCell addition.

### A Measurement Result of the Neighbour Cell.

In some embodiments, the list and/or measurement result of the at least one candidate PSCell includes at least one of the following.
A list and/or measurement result of at least one candidate PSCell when the conditional PSCell addition fails.
A list and/or measurement result of at least one candidate PSCell when the SCG failure occurs.

In some embodiments, the list and/or measurement result of the at least one non-candidate PSCell includes at least one of the following.
A list and/or measurement result of at least one non-candidate PSCell when the conditional PSCell addition fails.
A list and/or measurement result of at least one non-candidate PSCell when the SCG failure occurs.

In some embodiments, the location information of the terminal includes at least one of the following.
Location information of the terminal when the conditional PSCell addition fails.
Last location information of the terminal recorded before the conditional PSCell addition fails.
Location information of the terminal when the SCG failure occurs.
Last location information of the terminal recorded before the SCG failure occurs.

In some embodiments, the measurement result of the neighbour cell includes at least of the following.
A measurement result of the neighbour cell when the conditional PSCell addition fails.
A measurement result of the neighbour cell when the SCG failure occurs.

In some embodiments, the sending module 920 is configured to send the first information to the network device, in response to the conditional PSCell addition failing. Alternatively, in response to the SCG failure occurring, the sending module 920 is configured to send the first information to the network device.

In some embodiments, the first information is carried in any one of the following signaling: the uplink information response and the SCG failure information reporting.

In some embodiments, the first information includes at least one of the following information.
A time difference between a first moment and a second moment. The first moment is a moment at which the terminal receives a signaling of the conditional PSCell addition, and the second moment is a moment at which the terminal performs the conditional PSCell addition.
An addition trigger condition applied to at least one candidate PSCell.
A list and/or measurement result of the at least one candidate PSCell when the conditional PSCell addition successing.
A list and/or measurement result of the at least one non-candidate PSCell when the conditional PSCell addition successing.
Location information of the terminal when the conditional PSCell addition successing. An addition trigger condition configured for a target PSCell.
A first indication or a second indication. The first indication is configured to indicate that the PSCell addition performed by the terminal is the conditional PSCell addition, and the second indication is configured to indicate that the PSCell addition performed by the terminal is traditional PSCell addition.
A measurement result of a neighbour cell when the conditional PSCell addition successes.

In some embodiments, the sending module 920 is configured to send the first information, in response to the conditional PSCell addition successing. Alternatively, the sending module 920 is configured to send the first information, in response to the conditional PSCell addition successing and the reporting trigger condition being satisfied.

The sending module 920 is configured to include at least one of the following reporting trigger conditions.
A time difference between the first moment and the second moment is greater than a first threshold.
The first moment is a moment at which the terminal receives a signaling of the conditional PSCell addition, and the second moment is a moment at which the terminal performs the conditional PSCell addition.
A time difference between the second moment and a fifth moment is greater than a second threshold. The second moment is a moment at which the terminal performs the conditional PSCell addition, and the fifth moment is a moment at which the conditional PSCell addition is successfully finished.

In some embodiments, the sending module 920 is configured to carry the first information in any one of the following signaling: the uplink information response and the successful PSCell addition information reporting.

In some embodiments, the optimizing apparatus further includes a receiving module 940.

The sending module 920 is configured to send indication information, and the indication information is configured to indicate the terminal has the first information. The receiving module 940 is configured to receive a reporting signaling, and the reporting signaling is configured to indicate the terminal to send the first information.

FIG. 10 is a structural block view of an optimizing apparatus for the conditional PSCell addition according to some embodiments of the present disclosure. The optimizing apparatus may be applied in the network device by a software, or a hardware, or a combination of both. The optimizing apparatus includes the following.

The receiving module 1020 is configured to receive the first information.

The optimizing module 1040 is configured to optimize configuration information of conditional PSCell addition according to the first information.

In some embodiments, the first information includes at least one of the following information.
A time difference between a first moment and a second moment. The first moment is a moment at which the terminal receives a signaling of the conditional PSCell addition, and the second moment is a moment at which the terminal performs the conditional PSCell addition.
An addition trigger condition applied to at least one candidate PSCell.
A list and/or measurement result of the at least one candidate PSCell.
A list and/or measurement result of at least one non-candidate PSCell.
A time difference between a third moment and a fourth moment. The third moment is a moment at which the PSCell addition is performed, and the fourth moment is a moment at which the SCG failure occurs.
Location information of the terminal.
An addition trigger condition configured for a target PSCell.
A first indication or a second indication. The first indication is configured to indicate that the PSCell addition performed by the terminal is the conditional PSCell addition, and the second indication is configured to indicate that the PSCell addition performed by the terminal is traditional PSCell addition.
A measurement result of a neighbour cell.
A cell identifier of a PSCell expected to be accessed.

In some embodiments, the first information is carried in any one of the following signaling: the uplink information response, and the SCG failure information reporting.

In some embodiments, the first information includes at least one of the following information.
A time difference between a first moment and a second moment. The first moment is a moment at which the terminal receives a signaling of the conditional PSCell addition, and the second moment is a moment at which the terminal performs the conditional PSCell addition.
An addition trigger condition applied to at least one candidate PSCell.
A list and/or measurement result of the at least one candidate PSCell when the conditional PSCell addition successes.
A list and/or measurement result of the at least one non-candidate PSCell when the conditional PSCell addition successes.
Location information of the terminal when the conditional PSCell addition successes.
An addition trigger condition configured for a target PSCell.
A first indication or a second indication. The first indication is configured to indicate that the PSCell addition performed by the terminal is the conditional PSCell addition, and the second indication is configured to indicate that the PSCell addition performed by the terminal is a traditional PSCell addition.
A measurement result of a neighbour cell when the conditional PSCell addition successes.
A cell identifier of a PSCell expected to be accessed when the conditional PSCell addition successes.

In some embodiments, the first information is sent from the terminal, in response to the conditional PSCell addition successing. Alternatively, the first information is sent from the terminal, in response to the conditional PSCell addition successing and the reporting trigger condition being satisfied.

In some embodiments, the reporting trigger condition includes at least one of the following conditions.
A time difference between the first moment and the second moment is greater than a first threshold.
The first moment is a moment at which the terminal receives a signaling of the conditional PSCell addition, and the second moment is a moment at which the terminal performs the conditional PSCell addition.
A time difference between the second moment and a fifth moment is greater than a second threshold. The second moment is a moment at which the terminal performs the conditional PSCell addition, and the fifth moment is a moment at which the conditional PSCell addition is successfully finished.

In some embodiments, the first information is carried in any one of the following signaling: the uplink information response, and the successful PSCell addition information reporting.

In some embodiments, the optimizing apparatus further includes a sending module 1060.

The receiving module 1020 is configured to receive indication information, and the indication information is configured to indicate that the terminal has the first information.

The sending module 1060 is configured to send a reporting signaling, and the reporting signaling is configured to indicate the terminal to send the first information.

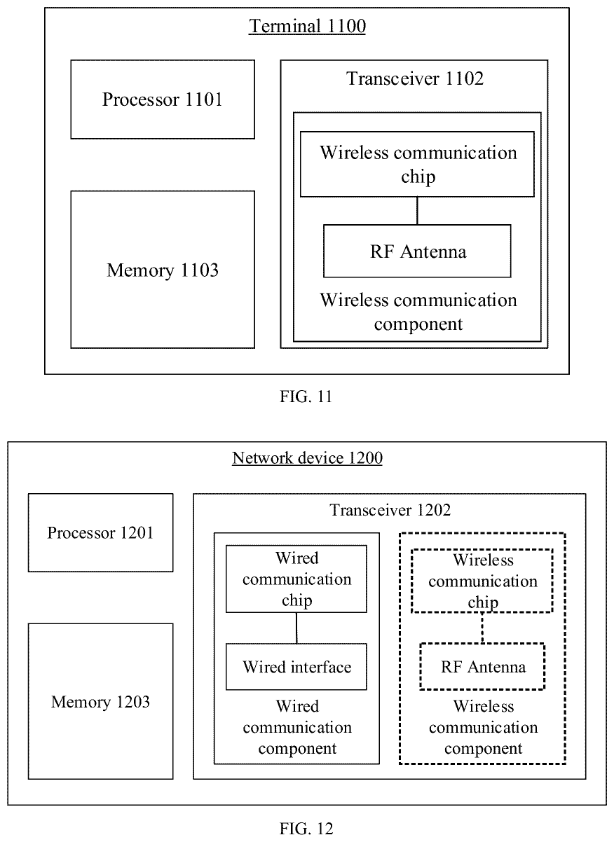

FIG. 11 is a structural view of a terminal 1100 according to some embodiments of the present disclosure. The terminal 1100 may include a processor 1101, a transceiver 1102, and a memory 1103.

The processor 1101 includes one or more processing cores, and the processor 1101 performs various functional applications and information processing by running software programs and modules.

The transceiver 1102 may include a receiver and a transmitter. For example, the receiver and the transmitter may be realized a single wireless communication component, and the wireless communication component may include a wireless communication chip and an RF antenna.

The memory 1103 may be connected to the processor 1101 and the transceiver 1102.

The memory 1103 may be configured to store a computer program, and the processor 1101 is configured to execute the computer program to implement each operation performed by the terminal in the wireless communication system in the embodiments of the methods described above.

In addition, the memory 1103 may be implemented by any type of a volatile or a non-volatile storage device or a combination thereof. The volatile or non-volatile storage device includes, but is not limited to: a disk or optical disks, an electrically erasable programmable read-only memory, an erasable programmable read-only memory, a static ready-to-access memory, a read-only memory, a magnetic memory, a flash memory, and a programmable read-only memory.

FIG. 12 is a structural view of a network device 1200 according to some embodiments of the present disclosure. The network device 1200 may include a processor 1201, a transceiver 1202, and a memory 1203.

The processor 1201 includes one or more processing cores, and the processor 1201 performs various functional applications and information processing by running software programs and modules.

The transceiver 1202 may include a receiver and a transmitter. For example, the receiver and the transmitter may be realized a single wireless communication component, and the wireless communication component may include a wireless communication chip and an RF antenna.

The memory 1203 may be connected to the processor 1201 and the transceiver 1202.

The memory 1203 may be configured to store a computer program, and the processor 1201 is configured to execute the computer program to implement each operation performed by the network device in the wireless communication system in the embodiments of the methods described above.

In addition, the memory 1203 may be implemented by any type of a volatile or a non-volatile storage device or a combination thereof. The volatile or non-volatile storage device includes, but is not limited to: a disk or optical disks, an electrically erasable programmable read-only memory, an erasable programmable read-only memory, a static ready-to-access memory, a read-only memory, a magnetic memory, a flash memory, and a programmable read-only memory.

The embodiments of the present disclosure further provide a computer-readable storage medium and the storage medium stores at least one instruction, at least one program, code set or instruction set. The at least one instruction, the at least one program, the code set or instruction set are loaded and executed by the processor to cause the processor to perform the optimizing method for the conditional PSCell addition performed by a first terminal, or a second terminal, or a network device in the embodiments described above.

The embodiments of the present disclosure further provide a computer program product or computer product. The computer program product or computer product includes computer instructions that are stored in the computer-readable storage medium. The computer instructions are loaded from the computer-readable storage medium and executed by the processor of a communication device to cause the communication device to perform the optimizing method for the conditional PSCell addition performed by a first terminal, or a second terminal, or a network device in the embodiments described above.

What have been mentioned above are merely some embodiments of the present disclosure and are not intended to limit the present disclosure. Any modifications, equivalent substitutions, improvements, etc. made within the spirit and principles of the present disclosure shall be included in the scope of the present disclosure.

What is claimed is:

1. An optimizing method for conditional primary secondary cell PSCell addition, performed by a terminal, comprising:
sending first information, the first information being configured to optimize configuration information of the conditional PSCell addition.

2. The optimizing method as claimed in claim 1, wherein the first information comprises at least one of:
a time difference between a first moment and a second moment, wherein the first moment is a moment at which the terminal receives a signaling of the conditional PSCell addition, and the second moment is a moment at which the terminal performs the conditional PSCell addition;
an addition trigger condition applied to at least one candidate PSCell;
a list and/or measurement result of the at least one candidate PSCell;
a list and/or measurement result of at least one non-candidate PSCell;
a time difference between a third moment and a fourth moment, wherein the third moment is a moment at which PSCell addition is performed, and the fourth moment is a moment at which a SecondaryCellGroup (SCG) failure occurs;
location information of the terminal;
an addition trigger condition configured for a target PSCell;
a first indication or a second indication, wherein the first indication is configured to indicate that the PSCell addition performed by the terminal is the conditional PSCell addition, and the second indication is configured to indicate that the PSCell addition performed by the terminal is traditional PSCell addition; and
a measurement result of a neighbour cell.

3. The optimizing method as claimed in claim 2, wherein the list and/or measurement result of the at least one candidate PSCell comprises at least one of:
a list and/or measurement result of at least one candidate PSCell in response to the conditional PSCell addition failing; and
a list and/or measurement result of at least one candidate PSCell in response to the SCG failure occurring.

4. The optimizing method as claimed in claim 1, wherein the first information is carried in at least one of:
an uplink information response; and
a SCG failure information reporting.

5. The optimizing method as claimed in claim 1, wherein the first information comprises at least one of:
a time difference between a first moment and a second moment, wherein the first moment is a moment at which the terminal receives a signaling of the conditional PSCell addition, and the second moment is a moment at which the terminal performs the conditional PSCell addition;
an addition trigger condition applied to at least one candidate PSCell;
a list and/or measurement result of the at least one candidate PSCell in response to the conditional PSCell addition successing;
a list and/or measurement result of at least one non-candidate PSCell in response to the conditional PSCell addition successing;
location information of the terminal in response to the conditional PSCell addition successing;
an addition trigger condition configured for a target PSCell;
a first indication or a second indication, wherein the first indication is configured to indicate that PSCell addition performed by the terminal is the conditional PSCell addition, and the second indication is configured to indicate that the PSCell addition performed by the terminal is a traditional PSCell addition; and
a measurement result of a neighbour cell in response to the conditional PSCell addition successing.

6. A terminal, comprising:
a processor;
a transceiver, connected to the processor; and
a memory, configured to store instructions to be executable by the processor;
wherein the processor is configured to load and execute the instructions to perform an optimizing method for conditional primary secondary cell PSCell addition and the optimizing method comprises:
sending first information, the first information being configured to optimize configuration information of the conditional PSCell addition.

7. The terminal as claimed in claim 6, wherein the first information comprises at least one of:
a time difference between a first moment and a second moment, wherein the first moment is a moment at which the terminal receives a signaling of the conditional PSCell addition, and the second moment is a moment at which the terminal performs the conditional PSCell addition;
an addition trigger condition applied to at least one candidate PSCell;
a list and/or measurement result of the at least one candidate PSCell;
a list and/or measurement result of at least one non-candidate PSCell;
a time difference between a third moment and a fourth moment, wherein the third moment is a moment at which PSCell addition is performed, and the fourth moment is a moment at which a SecondaryCellGroup (SCG) failure occurs;
location information of the terminal;
an addition trigger condition configured for a target PSCell;
a first indication or a second indication, wherein the first indication is configured to indicate that the PSCell addition performed by the terminal is the conditional PSCell addition, and the second indication is configured to indicate that the PSCell addition performed by the terminal is traditional PSCell addition; and
a measurement result of a neighbour cell.

8. The terminal as claimed in claim 7, wherein the list and/or measurement result of the at least one candidate PSCell comprises at least one of:
a list and/or measurement result of at least one candidate PSCell in response to the conditional PSCell addition failing; and
a list and/or measurement result of at least one candidate PSCell in response to the SCG failure occurring.

9. The terminal as claimed in claim 7, wherein the list and/or measurement result of the at least one non-candidate PSCell comprises at least one of:
a list and/or measurement result of at least one non-candidate PSCell in response to the conditional PSCell addition failing; and
a list and/or measurement result of at least one non-candidate PSCell in response to the SCG failure occurring.

10. The terminal as claimed in claim 7, wherein the location information of the terminal comprises at least one of:
location information of the terminal in response to the conditional PSCell addition failing;
last location information of the terminal recorded before the conditional PSCell addition fails;
location information of the terminal in response to the SCG failure occurring; and
last location information of the terminal recorded before the SCG failure occurs.

11. The terminal as claimed in claim 7, wherein the measurement result of the neighbour cell comprises at least one of:
a measurement result of a neighbour cell in response to the conditional PSCell addition failing;
a measurement result of a neighbour cell in response to the SCG failure occurring;
a last measurement result of a neighbour cell before the conditional PSCell addition fails; and
a last measurement result of the neighbour cell before the SCG failure occurs.

12. The terminal as claimed in claim 8, wherein the sending the first information comprises any one of:
sending the first information, in response to the conditional PSCell addition failing;
sending the first information, in response to the SCG failure occurring.

13. The terminal as claimed in claim 6, wherein the first information is carried in at least one of:
an uplink information response; and
a SCG failure information reporting.

14. The terminal as claimed in claim 6, wherein the first information comprises at least one of:
a time difference between a first moment and a second moment, wherein the first moment is a moment at which the terminal receives a signaling of the conditional PSCell addition, and the second moment is a moment at which the terminal performs the conditional PSCell addition;
an addition trigger condition applied to at least one candidate PSCell;
a list and/or measurement result of the at least one candidate PSCell in response to the conditional PSCell addition successing;
a list and/or measurement result of at least one non-candidate PSCell in response to the conditional PSCell addition successing;
location information of the terminal in response to the conditional PSCell addition successing;
an addition trigger condition configured for a target PSCell;
a first indication or a second indication, wherein the first indication is configured to indicate that PSCell addition performed by the terminal is the conditional PSCell addition, and the second indication is configured to indicate that the PSCell addition performed by the terminal is traditional PSCell addition; and
a measurement result of a neighbour cell in response to the conditional PSCell addition successing.

15. The terminal as claimed in claim 14, wherein the sending the first information comprises any one of:
sending the first information, in response to the conditional PSCell addition successing; and
sending the first information, in response to the conditional PSCell addition successing and a reporting trigger condition being satisfied.

16. A network device, comprising:
a processor;
a transceiver, connected to the processor; and
a memory, configured to store instructions to be executable by the processor;
wherein the processor is configured to load and execute the instructions to perform an optimizing method for conditional primary secondary cell PSCell addition and the optimizing method comprises:
receiving first information; and
optimizing configuration information of the conditional PSCell addition according to the first information.

17. The network device as claimed in claim 16, wherein the first information comprises at least one of:
a time difference between a first moment and a second moment, wherein the first moment is a moment at which a terminal receives a signaling of the conditional PSCell addition, and the second moment is a moment at which the terminal performs the conditional PSCell addition;
an addition trigger condition applied to at least one candidate PSCell;
a list and/or measurement result of the at least one candidate PSCell;
a list and/or measurement result of at least one non-candidate PSCell;
a time difference between a third moment and a fourth moment, wherein the third moment is a moment at which PSCell addition is performed, and the fourth moment is a moment at which a SecondaryCellGroup (SCG) failure occurs;
location information of the terminal;
an addition trigger condition configured for a target PSCell;
a first indication or a second indication, wherein the first indication is configured to indicate that the PSCell addition performed by the terminal is the conditional PSCell addition, and the second indication is configured to indicate that the PSCell addition performed by the terminal is traditional PSCell addition;
a measurement result of a neighbour cell.

18. The network device as claimed in claim 17, wherein the list and/or measurement result of the at least one candidate PSCell comprises at least one of:
a list and/or measurement result of at least one candidate PSCell in response to the conditional PSCell addition failing; and
a list and/or measurement result of at least one candidate PSCell in response to the SCG failure occurring.

19. The network device as claimed in claim 16, wherein the first information is carried in at least one of:
an uplink information response; and
a SCG failure information reporting.

20. The network device as claimed in claim 16, wherein the first information comprises at least one of:
a time difference between a first moment and a second moment, wherein the first moment is a moment at which a terminal receives a signaling of the conditional PSCell addition, and the second moment is a moment at which the terminal performs the conditional PSCell addition;
an addition trigger condition applied to at least one candidate PSCell;
a list and/or measurement result of the at least one candidate PSCell in response to the conditional PSCell addition successing;
a list and/or measurement result of at least one non-candidate PSCell in response to the conditional PSCell addition successing;
location information of the terminal in response to the conditional PSCell addition successing;
an addition trigger condition configured for a target PSCell;
a first indication or a second indication, wherein the first indication is configured to indicate that PSCell addition performed by the terminal is the conditional PSCell addition, and the second indication is configured to indicate that the PSCell addition performed by the terminal is traditional PSCell addition; and
a measurement result of a neighbour cell in response to the conditional PSCell addition successing.
